(19) United States
(12) Patent Application Publication
(10) Pub. No.: US 2001/0045330 A1
(43) Pub. Date: Nov. 29, 2001

(54) Bicycle brake shoe

(76) Inventors: Chung-Ping Chiang, Taipei (TW); Pai-Hsiang Hsu, Tainan (TW); Caesar Chen, Pate City (TW); Ching-Huan Tseng, Hsinchu (TW)

Correspondence Address: PRO-TECHTOR INTERNATIONAL, 20775 Norada Court, Saratoga, CA, 95070-3018, US

(21) Appl. No.: 09/924,748

(22) Filed: Aug. 7, 2001

Related U.S. Application Data
(63) Continuation-in-part of application No. 09/395,883, filed on Sep. 14, 1999, now abandoned.

(51) Int. Cl. F16D 65/14; B62L 1/02

(52) U.S. Cl. 188/24.12; 188/205 R; 188/250 B

(57) ABSTRACT

A bicycle brake shoe, comprising: a support bar; a seat; a brake pad, which is mounted on the seat and for braking pressed against a wheel rim on a contact surface having a front end which faces an opposite movement of the wheel rim; a moving block, mounted on the seat close to the front end of the brake pad, projecting from the brake pad towards the wheel rim, pressed by a spring. The moving block is movable perpendicular to the contact surface of the brake pad and has a projecting surface which upon braking touches the wheel rim prior to the contact surface of the brake pad, scraping water, gravel and dirt from the wheel rim. Thus a braking effect unhampered by water or dirt is achieved.

This is a continuation-in-part application of applicant's U.S. patent application Ser. No. 09/395,883, filed on Sep. 14, 1999.

### BACKGROUND OF THE INVASION

1. Field of the Invention

The present invention relates to a bicycle brake shoe, particularly to a bicycle brake shoe for a caliper or cantilever brake.

2. Description of Related Art

A conventional caliper or cantilever brake on a bicycle wheel with a rim has a pair of lever arm that pivotly mounted on both sides of the bicycle wheel, carrying brake shoes. For braking, the brake shoes are pressed against the wheel rim, decelerating the wheel by friction.

Since the wheel is in direct contact with the ground, without protection, running through rain or on a wet track will cover the wheel rim with a water film or with dirt, As a result, friction of the brake shoes against the wheel rim is reduced and no satisfactory braking effect is achieved Furthermore, small stones and gravel wilt be stuck on the brake shoes, wearing or damaging the wheel rim in subsequent braking operations.

The discrepancy of the braking effect under dry and wet conditions has mostly been resolved by increasing the braking shoes in length to increase the projecting surface with the wheel rim or by using a material for the braking shoes with high friction under wet conditions. However, this does not remedy the above problem because the braking force under dry conditions is too strong, carrying the risk of blocking the wheel.

Therefore, Taiwan patent no. 85217389 has disclosed a brake pad made of two different materials the composition of which is chosen according to humidity. Still this pad does not accommodate dry and wet conditions simultaneously and has to be exchanged with changing weather.

Furthermore U.S. Pat. No. 5,064,027 has disclosed a braking shoe, having a front end with a projection. The projection allows to determine a suitable angle for installing the brake shoe to control the friction between the brake shoe and the wheel rim. During use of the brake, the projection is worn off. U.S. Pat. No. Dse. 379,344 also teaches a projection on the front end of the brake shoe. These patents allow to control changes in the installation of the braking shoe, but fail to compensate for different braking effects under dry and wet conditions.

### SUMMARY OF THE INVENTION

It is therefore the main object of the present invention to provide a bicycle braking shoe which is suitable for various weather conditions, without a need to Age material.

Another object of the present invention is to provide a bicycle braking shoe with a braking effect bad by a water film or gravel.

The main characteristic of the present invention is a moving member, which upon braking contacts the Gel rim before the braking pad, scraping off a water film, gravel or dirt and ensuring an unhampered braking effect.

The present invention can be more fully understood by reference to the following description and accompanying drawings.

### BRIEF DESCRIPTION OF THE DRAWINGS

FIG. 1 is a side view of the bicycle brake shoe of the present invention in the first embodiment.

FIG. 2 is a top view of the bicycle brake shoe of the present invention in the first embodiment.

FIG. 3 is a schematic illustration of the beginning movement of the present invention in the first embodiment.

FIG. 3A is a schematic illustration of the completed movement of the present invention in the first embodiment.

FIG. 4 is a side view of the bicycle brake shoe of the present invention in the second embodiment.

FIG. 5 is a perspective view of the elastic plate of the present invention in the second embodiment.

FIG. 6 is a side view of the bicycle brake shoe of the present invention in the third embodiment.

FIG. 7 is a top view of the bicycle brake shoe of the present invention in the third embodiment.

FIG. 8 is a side view of the bicycle brake shoe of the present invention in the fourth embodiment.

FIG. 9 is a side view of the bicycle brake shoe of the present invention in the fifth embodiment.

FIG. 10 (prior art) is a side view of a conventional bicycle brake shoe.

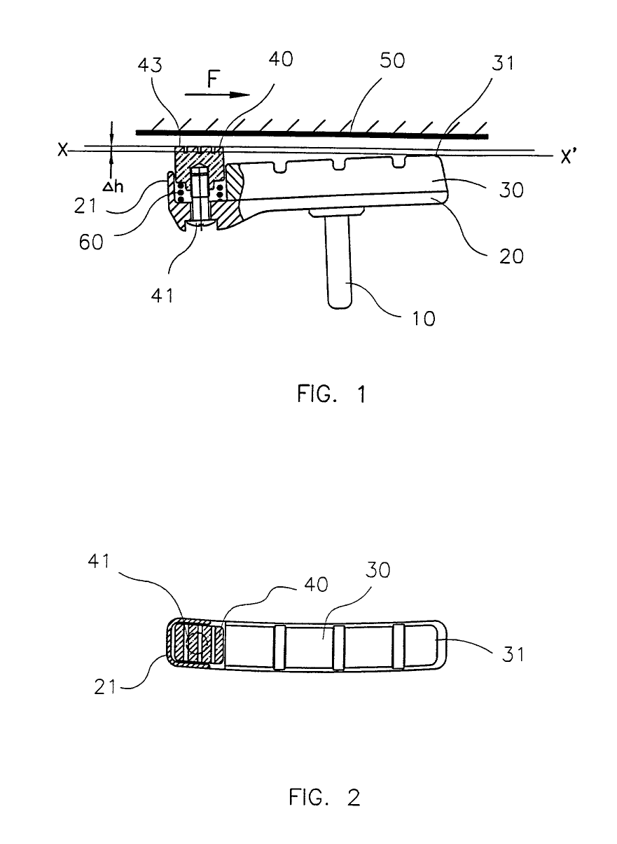

### DETAILED DESCRIPTION OF THE PREFERRED EMBODIMENTS

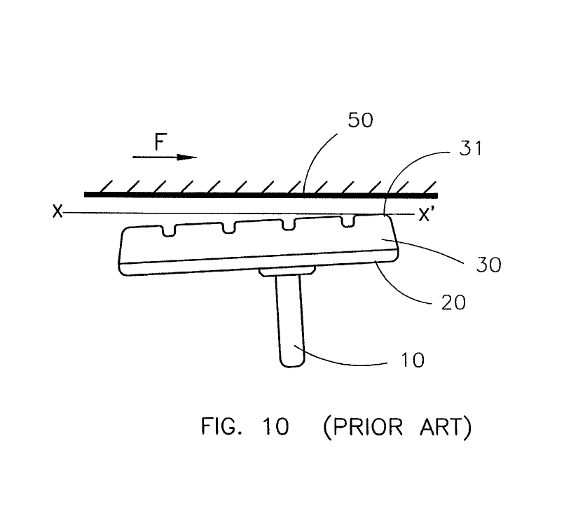

As shown in FIG. 10, a conventional bicycle brake shoe comprises: a support member 10; a seat 20; and a brake pad 30. The support member 10 is mounted on a lever arm of a braking system (not shown). A braking effect is achieved by contacting a wheel rim 50, as driven by the lever arm. In a resting state, the brake shoe is inclined with respect to line X-X′, which is parallel to the wheel rim 50. The wheel rim 50 performs a movement indicated by arrow F. Up braking, the brake shoe first touches the wheel rim 50 at a rear point 31.

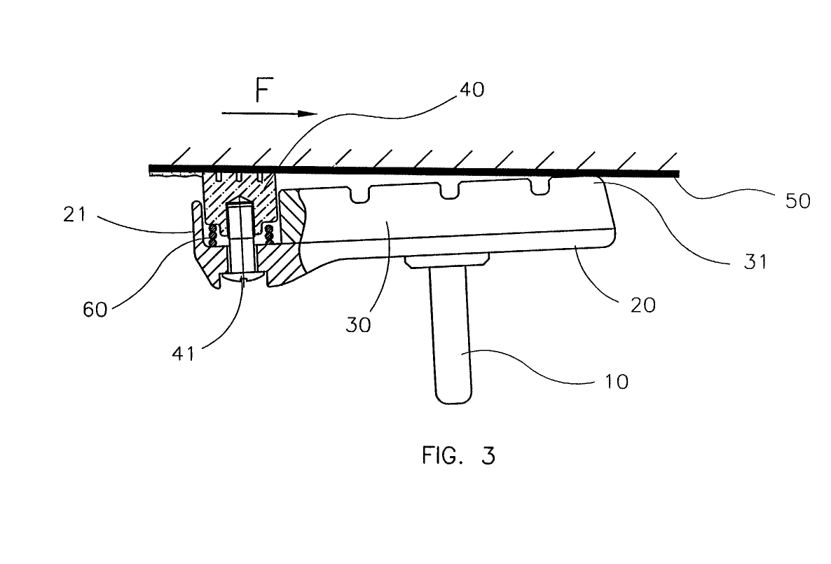

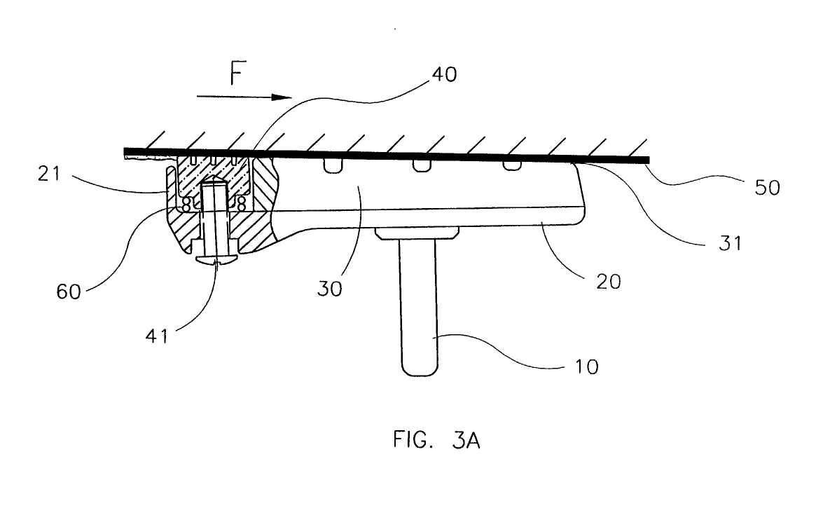

Referring to FIG. 1, the bicycle brake shoe of the preset invention, in addition to a conventional bicycle brake shoe, has a front end with a movable member 40. The movable member 40 has a projecting surface 43 for contacting the wheel rim 50. In the resting state, with the projecting surface 43 not touching the wheel rim 50, the movable member 40 projects from the brake pad 30. Then the projecting surface 43 and the rear point 31, passed throb by the line X-X′, keep a distance A from the wheel rim 50. As shown in FIG. 3, when the brake pad 30 moves towards the wheel rim 50, the moving block 40 first touches the wheel rim 50, earlier than the rear point 31, and scrapes off water, gravel and dirt. When the brake pad 30 contacts the wheel rim 50, an undiminished braking effect will be achieved.

The movable member 40 is mounted on the seat 20 by a screw 41. The screw 41 is oriented perpendicular nearly to the projecting surface 43 and is movable back and forth on the seat 20. Thus the movable fiber is movable back and forth in a direction perpendicular to the wheel rim 50. As shown in FIG. 3, when the brake pad 30, after contacting the wheel rim 50, is pressed further thereon the moving block 40 is back, allowing the brake pad 30 to get into full contact with the wheel rim 50. A spring 60 is inserted between the moving block 40 and the seat 20, pressing the moving block 40 this the Weal rim 50. After the brake pad 30 has separated from the wheel rim 50, the spring 60 pushes the moving block 40 to project from the brake pad 30, as in the resting state.

In a first embodiment of the present invention, the spring 60 is a helical spring, located bet the moving block 40 and the seat 20, The screw 41 connects the moving block 40 with the seat 20. The spring 60 is compressed, subject to tension As own in FIG. 9 a cover 21 surrounds the spring 60, so as to prevent water and dirt from damaging the spring 60.

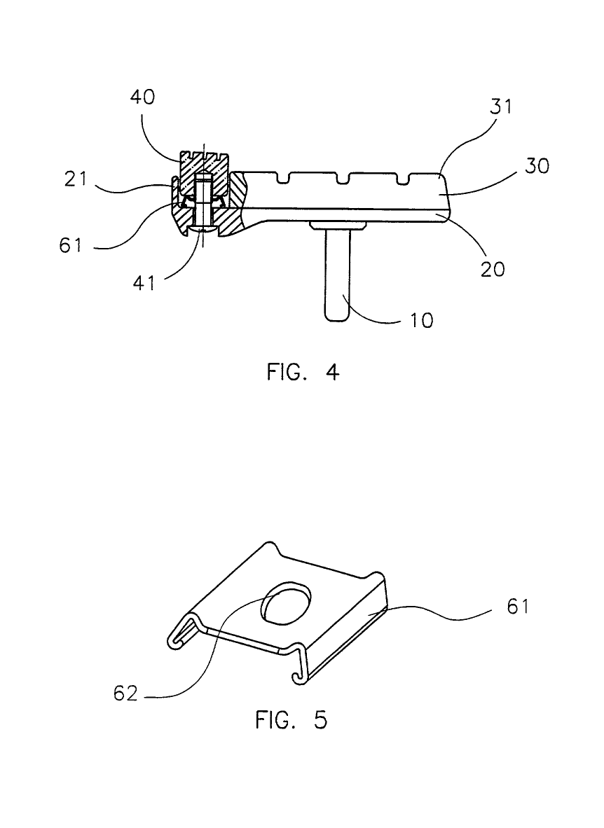

Referring to FIGS. 4 and 5, the present invention in a second embodiment has an elastic plate 61, substituted for the spring 60. The elastic plate 61 has a central hole 62, which is passed through by the screw 41 The elastic plate 61 offers good tension, while requiring little space.

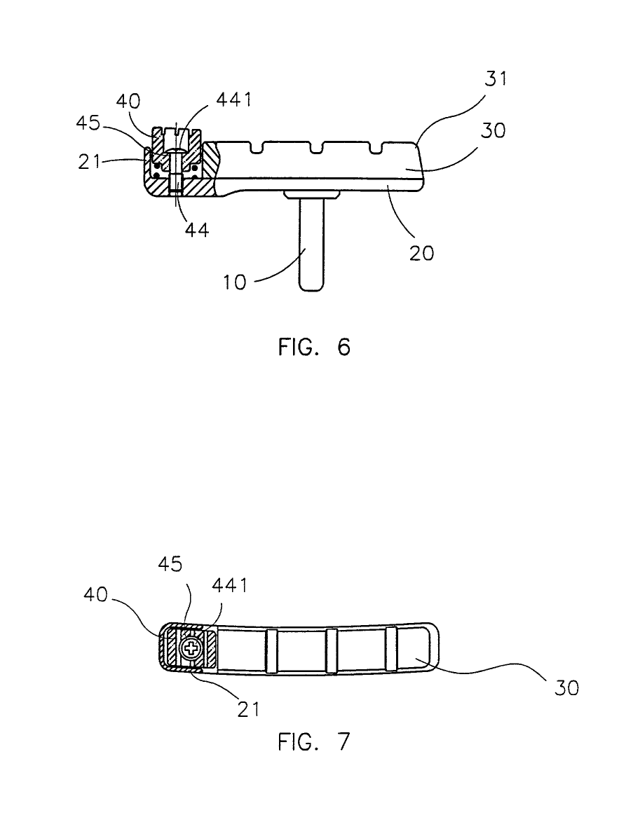

Referring to FIGS. 6 and 7, the present invention in a third embodiment has an opening 45 through the moving block 40. A threaded bolt 44 with a head 441 passes through the opening 45. The bolt 44 has a diameter that is smaller than the diameter of the opening 45, while the head 441 has a diameter that is larger than the differ of the opening 45. Thus the moving block 40 is allowed to move back and forth on the bolt 44.

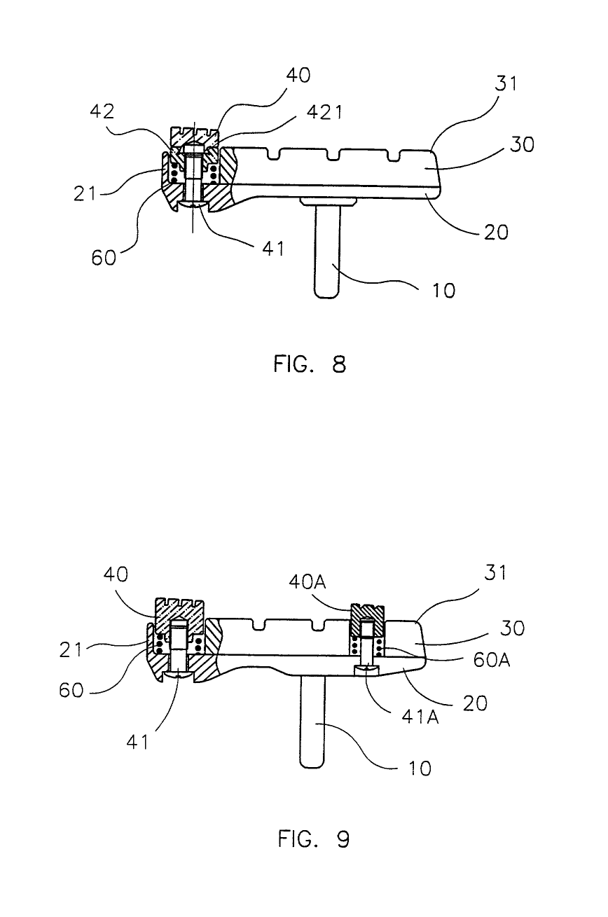

Referring to FIG. 8, the present invention in a fourth embodiment has a carrier 42 for the moving block 40. The moving block 40 is set on the carrier 42, and the carrier 42 in turn is mounted to the screw 41. A groove 421 on the carrier 42 cats to the moving block 40.

Referring to FIG. 9, the present invention in a fifth embodiment has a second moving block 40A, mounted an the seat 20, between said front end and said rear point 31 of the brake pad 30, held by a screw 41A and a spring 60A. The second moving block 40A scrapes water and gravel from the wheel rim 50 a second time. During slow motion of the wheel, after a first scraping by the moving block 40, water and dirt are given time to recollect on the wheel rim 50. The second moving block 40A then effectively cleans the wheel rim 50.

While the invent ion has been described with reference to preferred embodiments thereof, it is to be understood that modifications or variations may be easily me without departing from spirit of this invention which is defined by the appended claims.

1. A bicycle brake shoe, comprising:
a support seat member;
a brake pad mounted on said support seat member, said brake pad being pressed against a wheel rim on a contact surface during braking, said brake pad first touching said wheel rim on a rear point of said brake pad;
a movable member mounted on said support seat member at a front end of and adjacent to said brake pad, said movable member projecting from said support seat member towards said wheel rim, said movable member being movable independently of said brake pad and perpendicular to said contact surface of said wheel rim, and said movable member having a projecting surface at least as wide as a contact surface of said brake pad, so that upon braking, said projecting surface of said movable member touches said wheel rim in front of said brake pad, said projecting surface of said movable member thereby scraping water, gravel and dirt from said wheel rim.
